(19) United States
(12) Patent Application Publication
(10) Pub. No.: US 2024/0051404 A1
(43) Pub. Date: Feb. 15, 2024

(54) Rotor-Wheeled Motor Assembly With Integrated Inverter and Cooling Device for Electric Vehicles

(71) Applicant: Karma Automotive LLC, Irvine, CA (US)

(72) Inventors: Fazel Farahmand, Aliso Viejo, CA (US); Meisen Li, Rochester Hills, MI (US)

(73) Assignee: Karma Automotive LLC, Irvine, CA (US)

(21) Appl. No.: 17/819,063

(22) Filed: Aug. 11, 2022

(51) Int. Cl. B60L 50/51; H02P 27/06; H02K 7/116; H02K 9/19; H02K 5/16; H02K 1/16

(52) U.S. Cl. CPC B60L 50/51; H02P 27/06; H02K 7/116; H02K 9/19; H02K 5/16; H02K 1/16; B60L 2220/50; B60L 2220/44; B60L 2210/40

(57) ABSTRACT

A rotor-wheeled motor assembly includes a wheel that includes a rim coaxial with an axis of rotation of the wheel and circumscribing an interior region of the wheel. The rim has a tire mounting surface and an interior radial surface on an opposite side than the tire mounting surface and opposing the interior region. The tire mounting surface is configured to mount the wheel to a vehicle hub assembly. An electric motor is disposed within the interior region and includes a rotor disposed on or embedded into the tire mounting surface. The rotor is configured to rotate in unison with the tire mounting surface about the axis of rotation along a plane perpendicular to the axis of rotation. A stator assembly includes a stator core and stator windings. The stator windings axially oppose the rotor to define an axial flux air gap separating the rotor and the stator windings.

### TECHNICAL FIELD

This disclosure relates to a rotor-wheeled motor assembly with an integrated inverter and cooling device for electric vehicles.

### BACKGROUND

Modern vehicles may include motors that independently drive respective wheels of the vehicle. That is, a motor drives an individual wheel of the vehicle to, for example, independently deliver power to the wheel or supplement a primary powertrain of the vehicle. These motors can be disposed within an interior portion or chamber of the wheel. However, traditional in-wheel motors must deliver power to the wheel through a transmission, which adds undesirable weight on the vehicle suspension, prevents complete efficiency of power transfer from the motor to the wheel, and requires regular lubrication. This reduces efficiency of the powertrain and requires significant maintenance.

### SUMMARY

One aspect of the present disclosure provides a rotor-wheeled motor assembly. The rotor-wheeled motor assembly includes a wheel that includes a rim coaxial with an axis of rotation of the wheel and circumscribing an interior region of the wheel. The rim has a tire mounting surface and an interior radial surface disposed on an opposite side of the rim than the tire mounting surface and opposing the interior region. The tire mounting surface is arranged coaxially with the axis of rotation of the wheel and is configured to mount the wheel to a vehicle hub assembly. An electric motor is disposed within the interior region of the wheel. The electric motor includes a first rotor disposed on or embedded into the tire mounting surface of the wheel. The first rotor is configured to rotate in unison with the tire mounting surface about the axis of rotation along a plane perpendicular to the axis of rotation. A stator assembly of the electric motor includes a stator core and a first set of stator windings. The first set of stator windings are axially opposing the first rotor to define an axial flux air gap that separates the first rotor and the first set of stator windings.

Implementations of the disclosure may include one or more of the following optional features. In some implementations, the first rotor is disposed axially outward of the first set of stator windings. In some examples, the electric motor further includes a second rotor disposed on an inner mounting portion of the wheel. The inner mounting portion is coupled for common rotation about the axis of rotation of the wheel with the tire mounting surface such that the first rotor and the second rotor rotate in unison about the axis of rotation along respective planes perpendicular to the axis of rotation. In these examples, a second set of stator windings are axially opposing the second rotor.

Optionally, the rotor-wheeled motor assembly does not include a gearbox or transmission for transferring output torque from the electric motor for driving the wheel. In some implementations, the rotor-wheeled motor assembly is not cooled via liquid cooling. In other implementations, the rotor-wheeled motor assembly integrates conduits of an external liquid cooling system configured to circulate liquid for cooling the electric motor.

In some examples, the electric motor includes a permanent magnet motor. Optionally, the electric motor includes an induction motor. The electric motor may include a reluctance motor.

In some implementations, the vehicle hub assembly includes a rotating portion coupled for common rotation about the axis of rotation of the wheel, and a fixed portion that remains stationary during operation of the electric motor. In further implementations, the rotating portion of the vehicle hub assembly circumscribes the fixed portion of the vehicle hub assembly. In other further implementations, the fixed portion of the vehicle hub assembly circumscribes the rotating portion of the vehicle hub assembly. Optionally, further implementations include bearings configured to permit the rotating portion of the vehicle assembly to rotate about the axis of rotation relative to the fixed portion of the vehicle hub assembly. In some further implementations, the fixed portion of the vehicle hub assembly is fixedly attached to the stator.

In some examples, the rotor-wheeled motor assembly further includes an in-wheel cooling system configured to provide cooling to the electric motor disposed within the interior region of the wheel. In further examples, the in-wheel cooling system includes vents formed through and or into the mounting surface of the wheel that direct a flow of air into the interior region during operation of the electric motor. Optionally, the in-wheel cooling system includes vents formed through and or into the first rotor that direct a flow of air into the interior region during operation of the electric motor. The in-wheel cooling system may include cooling blades/fins that protrude into the interior region of the wheel.

Optionally, the electric motor further includes an inverter disposed in the interior region of the motor. The inverter is configured to convert direct current power supplied from one or more energy storage devices into alternating current for powering the electric motor. The wheel may be disposed on a car, truck, robot, or motor cycle.

Another aspect of the disclosure provides a rotor-wheeled motor assembly. The rotor-wheeled motor assembly includes a wheel that includes a rim coaxial with an axis of rotation of the wheel and circumscribing an interior region of the wheel. The rim has a tire mounting surface and an interior radial surface disposed on an opposite side of the rime than the tire mounting surface and opposing the interior region. The tire mounting surface is arranged coaxially with the axis of rotation of the wheel and is configured to mount the wheel to a vehicle hub assembly. An electric motor is disposed within the interior region of the wheel. The electric motor includes a first rotor disposed on or embedded into the interior radial surface of the rim of the wheel. The first rotor is configured to rotate in unison with the rim about the axis of rotation along a plane parallel to the axis of rotation. A stator assembly of the electric motor includes a stator core and a first set of stator windings. The first set of stator windings are radially opposing the first rotor to define a radial flux air gap that separates the first rotor and the first set of stator windings.

Implementations of the disclosure may include one or more of the following optional features. In some implementations, the electric motor further includes a second rotor disposed on a rotating portion of the vehicle hub assembly. The rotating portion is coupled for common rotation about the axis of rotation with the rim such that the first rotor and the second rotor rotate in unison about the axis of rotation along respective planes parallel to the axis of rotation. A second set of stator windings are radially opposing the second rotor to define another radial air gap that separates the second rotor and the second set of stator windings.

In some examples, the electric motor further includes a second rotor disposed on or embedded into one of the tire mounting surface or a rotating portion of the vehicle hub assembly. The second rotor is configured to rotate in unison with the tire mounting surface about the axis of rotation along a plane perpendicular to the axis of rotation.

Optionally, the rotor-wheeled motor assembly does not include a gearbox or transmission for transferring output torque from the electric motor for driving the wheel. In some implementations, the rotor-wheeled motor assembly is not cooled via liquid cooling. In other implementations, the rotor-wheeled motor assembly integrates conduits of an external liquid cooling system configured to circulate liquid for cooling the electric motor.

The electric motor may include a permanent magnet motor. In some examples, the electric motor includes an induction motor. Optionally, the electric motor includes a reluctance motor.

In some implementations, the vehicle hub assembly includes a rotating portion coupled for common rotation about the axis of rotation of the wheel, and a fixed portion that remains stationary during operation of the electric motor. In further implementations, the rotating portion of the vehicle hub assembly circumscribes the fixed portion of the vehicle hub assembly. In other further implementations, the fixed portion of the vehicle hub assembly circumscribes the rotating portion of the vehicle hub assembly. Optionally, further implementations include bearings configured to permit the rotating portion of the vehicle hub assembly to rotate about the axis of rotation relative to the fixed portion of the vehicle hub assembly. In some further implementations, the fixed portion of the vehicle hub assembly is fixedly attached to the stator.

In some examples, the rotor-wheeled motor assembly further includes an in-wheel cooling system configured to provide cooling to the electric motor disposed within the interior region of the wheel. In further examples, the in-wheel cooling system includes vents formed through and or into the mounting surface of the wheel that direct a flow of air into the interior region during operation of the electric motor. Optionally, the in-wheel cooling system includes vents formed through and or into the first rotor that direct a flow of air into the interior region during operation of the electric motor. The in-wheel cooling system may include cooling blades/fins that protrude into the interior region of the wheel.

Optionally, the electric motor further includes an inverter disposed in the interior region of the motor. The inverter is configured to convert direct current power supplied from one or more energy storage devices into alternating current for powering the electric motor. The wheel may be disposed on a car, truck, robot, or motor cycle.

The details of one or more implementations of the disclosure are set forth in the accompanying drawings and the description below. Other aspects, features, and advantages will be apparent from the description and the drawings, and from the claims.

### DESCRIPTION OF DRAWINGS

FIG. 1A is a cross-sectional view of a rotor-wheeled motor assembly having an axial motor at the interior portion of the wheel where a rotor of the motor is disposed at an inner mounting surface of the wheel and a stator assembly of the motor is disposed opposing the rotor and radially inboard of a rotating hub of the wheel.

FIG. 1B is a cross-sectional view of the rotor-wheeled motor assembly having an axial motor where the rotor is disposed at the inner mounting surface of the wheel and the stator assembly is disposed opposing the rotor and radially outward of the wheel hub.

FIG. 1C is a cross-sectional view of the rotor-wheeled motor assembly having an axial motor where a first rotor is disposed at the inner mounting surface of the wheel, a second rotor is disposed at an inner mounting portion of the wheel, and the stator assembly is disposed between and opposing the first and second rotors and radially outward of the wheel hub.

FIG. 1D is a cross-sectional view of the rotor-wheeled motor assembly having a radial motor where a first rotor is disposed at an inner surface of a rim of the wheel, a second rotor is disposed at the rotating wheel hub, and the stator assembly is disposed opposing the first and second rotors and radially outward of the wheel hub.

FIG. 1E is a cross-sectional view of the rotor-wheeled motor assembly having a combined radial-axial motor where a first rotor is disposed at the inner mounting surface of the wheel, a second rotor is disposed at the inner surface of the rim of the wheel, and the stator assembly is disposed opposing the first and second rotors, axially inboard of the first rotor and radially inboard of the second rotor.

FIG. 1F is a cross-sectional view of the rotor-wheeled motor assembly having a transverse rotor motor where the rotor is disposed at the wheel hub radially outward of the stator assembly and surrounding or sandwiching the stator assembly.

FIG. 1G is a cross-sectional view of the rotor-wheeled motor assembly having a transverse stator motor where the rotor extends from the wheel hub and is surrounded or sandwiched by the stator assembly.

FIG. 2 is a perspective view of a vehicle that may be equipped with any of the rotor-wheeled motor assemblies of FIGS. 1A-1G.

Like reference symbols in the various drawings indicate like elements.

### DETAILED DESCRIPTION

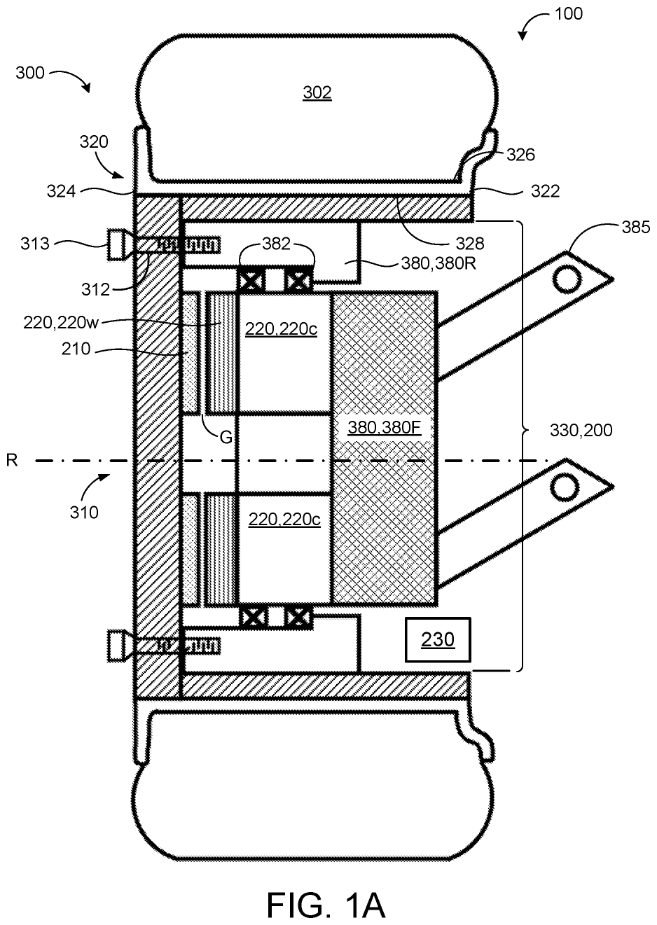

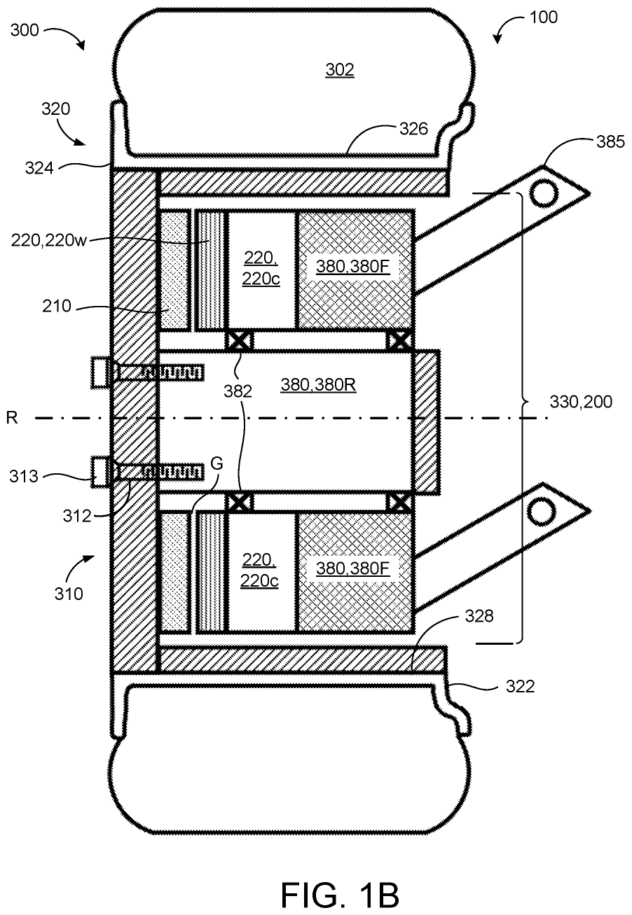

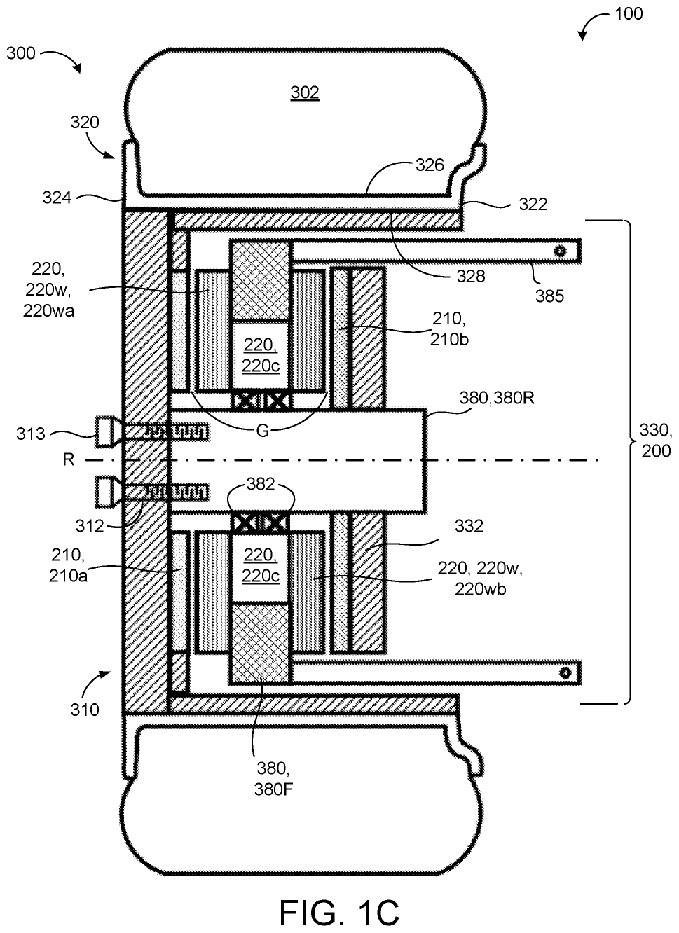

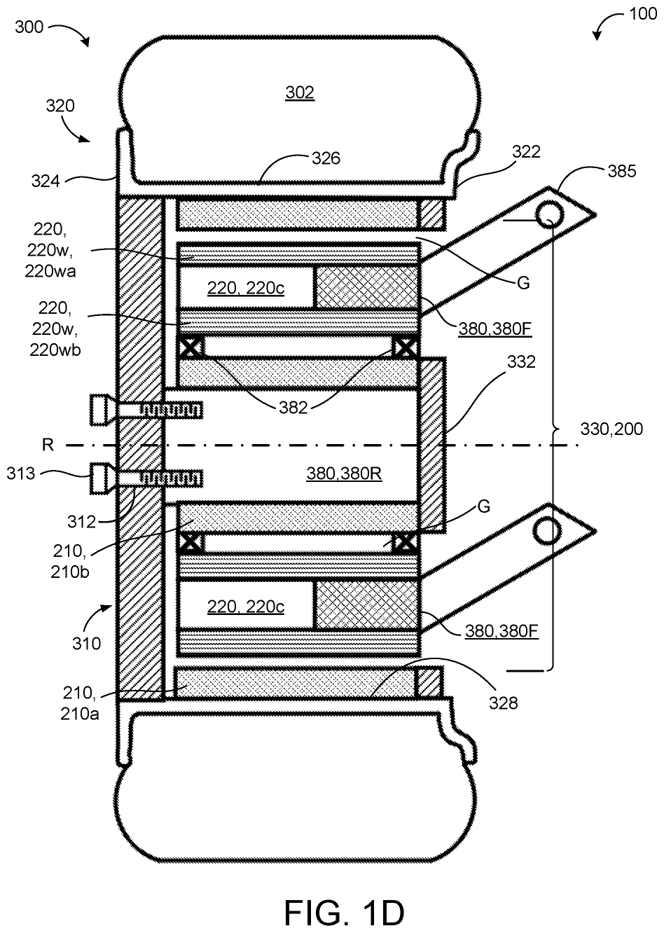

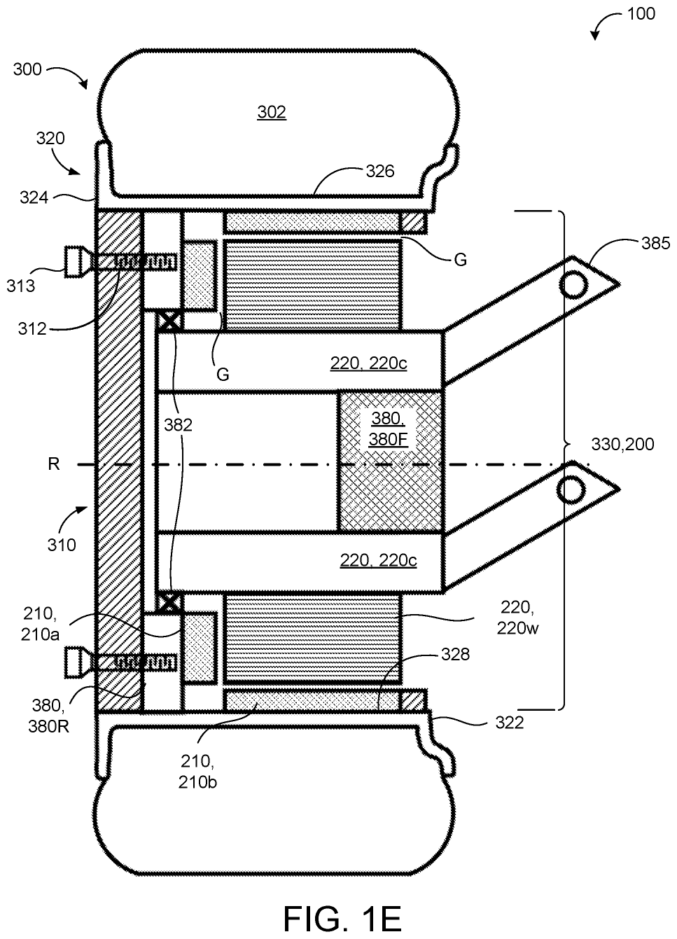

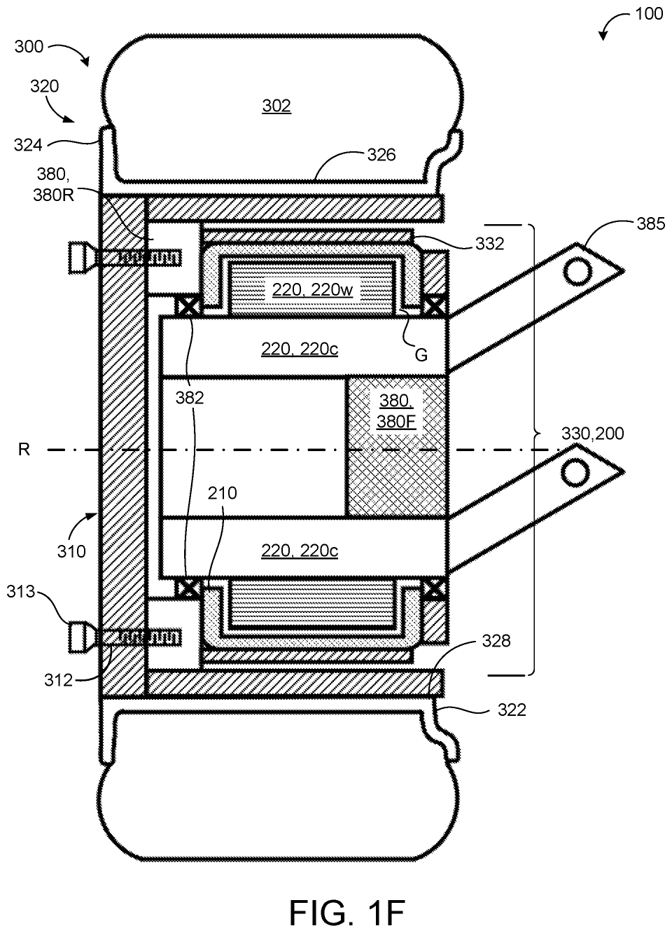

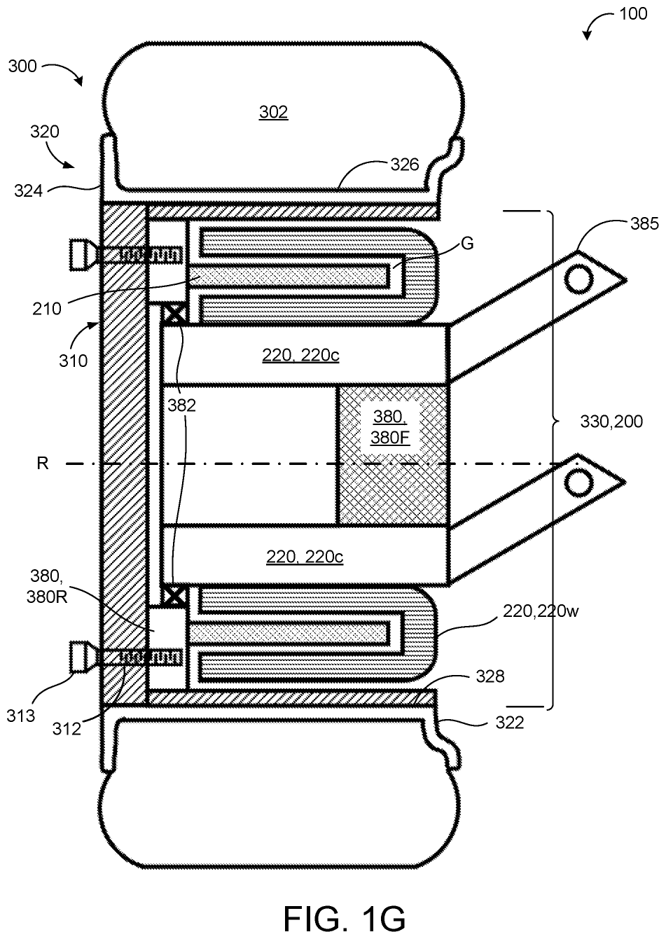

FIGS. 1A-1G illustrate a rotor-wheeled motor assembly 100 that integrates an electric motor 200 into an interior region 330 of a vehicle wheel 300 by embedding a rotor 210 of the electric motor 200 onto a mounting surface 310 (FIGS. 1A-1C) of the wheel 300, onto a rim 320 of the wheel 300 (FIGS. 1D and 1E), and/or onto a rotating portion 380R of a vehicle hub assembly 380 that the vehicle wheel 300 mounts onto (FIGS. 1F and 1G). The electric motor 200 may include any one of an axial motor (FIGS. 1A-1C), a radial motor (FIG. 1D), a combined radial-axial motor (FIG. 1E), a transverse rotor motor (FIG. 1F), or a transverse stator motor (FIG. 1G). Additionally, the electric motor 200 may include a permanent magnet (PM) motor, an induction motor, or a reluctance motor (i.e., synchronous reluctance motor). In the case of the PM motor, an array of permanent magnets may be disposed on a surface of the wheel 300 (or on a surface of a rotor core disposed on a surface of the wheel) to provide a surface PM motor or the array of permanent may be integrated/embedded into the wheel 300 (or into the rotor core) to provide an interior PM motor. Moreover, the rotor-wheeled motor assembly 100 includes a cooling structure, such as vents, blades, or fins, integrated with the structure of the wheel 300, such as the mounting surface 310, an interior radial surface 328, and an inner mounting surface 332, thus drawing or directing cooling air flow into the interior region 330 of the wheel 300 to cool the electric motor 200 as the wheel 300 rotates. Advantageously, this cooling structure is directing air flow occurring from natural air drag in order to provide cooling of the electric motor. By contrast, conventional in-wheel motors that attempt to reduce or eliminate such natural air drag which is considered wasteful since these conventional in-wheel motors use external cooling systems to cool down their motors.

Vehicles, including hybrid electric vehicles (HEVs) and electric vehicles (EVs) use electric motors as a powertrain traction source. In-wheel mounted electric motors (where the motor assembly is placed inside the wheel chamber), in particular, provide superior efficiency. However, traditional in-wheel motors deliver power through a gearbox and beam or drive shaft to the wheel, which increases the weight of the system and reduces the efficiency of the power transfer to the wheel. For example, typical gearboxes have efficiencies between 75 percent and 95 percent, or lower, depending on the operational speed and load. Additionally, the mechanical components of the gearbox and drive shaft are prone to failure and require regular lubrication and integration of a cooling system, such as an external liquid cooling system, which further decreases efficiency and increases maintenance costs.

As discussed further below, the rotor-wheeled assembly 100 includes the rotor 210 of the electric motor 200 integrated with or attached to an inner surface of the wheel assembly 300 that rotates with the wheel 300 so that the electric motor 200 directly drives the wheel 300 without need for a gearbox or transmission. A stator assembly 220 of the electric motor 200 is fixed at an interior region 330 of the wheel 300 and opposes the rotor 210 to impart rotational movement of the rotor 210 and wheel 300 with the fully assembled electric motor 200 fully contained within the interior chamber 330 of the wheel 300. Because the electric motor 200 directly drives the wheel 300, the rotor-wheeled assembly 100 reduces assembly and maintenance costs, reduces vehicle weight, and increases power transfer efficiency, thereby increasing range and power consumption efficiency. For example, the rotor-wheeled assembly 100 increases range and efficiency by 30 percent or more as compared to traditional in-wheel motor systems that transfer power through a gearbox to the wheel. Furthermore, the rotor-wheeled assembly 100 includes an integrated cooling system for cooling the electric motor 200, such as cooling vents and/or fins integrated within structure of the wheel 300, reducing or eliminating the need for liquid cooling systems.

The wheel 300 includes a rim 320 coaxial with an axis of rotation R of the wheel 300 and having an outer sidewall 324 defining an outer side of the wheel 300 and an inner sidewall 322 defining an inner side of the wheel 300. When the wheel 300 corresponds to one of four wheels of a car or truck, the outer sidewall 324 of the rim 320 may oppose the exterior of the car or truck. The wheel 300, may however, correspond to a wheel on any type of vehicle, such as a motor cycle. The rim 320 includes a tire mounting surface 326 extending between the outer sidewall 324 and the inner sidewall 322 and an interior radial surface 328 disposed on an opposite of the rim 320 than the tire mounting surface 326 and extending between the outer sidewall 324 and the inner sidewall 322. The interior radial surface 328 circumscribes an interior region 330 of the wheel 300 in which the electric motor 200 resides. The tire mounting surface 326 may be sized and shaped to accommodate the mounting of a tire 302 onto the rim 320 by conventional means.

The wheel 300 also includes a mounting surface 310 arranged coaxially with the axis of rotation R and configured to mount the wheel 300 to a vehicle hub assembly 380 by conventional means. The mounting surface 310 may be disposed along the outer side of the wheel and extend radially outward from the axis of rotation R to the rim. The mounting surface 310 may substantially enclose the interior region 330 of the wheel 300 from the exterior of the vehicle. In the examples shown, the mounting surface 310 is substantially flush with the outer sidewall 324 of the rim 320. In other examples, however, the mounting surface 310 (or at least portions of the mounting surface) are axially offset from the outer sidewall 324 of the rim 320 such that the mounting surface 310 is disposed axially between the outer and inner sidewalls 324, 322 of the rim 320.

Bores 312 may be formed through the mounting surface 310 that are adapted to receive fasteners 313 for mounting the wheel 300 to a rotating portion 380R of the vehicle hub assembly 380. For instance, the fasteners 313 may include threaded studs, nuts, or wheel bolts that secure the mounting surface 310 to the rotating portion 380R. The rotating portion 380R of the vehicle hub assembly 380 may include a drive shaft. When the mounting surface 310 is fastened to the rotating portion 380R of the vehicle hub assembly 380, the wheel 300 is mounted on the vehicle and configured to rotate about the axis of rotation R in unison with the rotating portion 380R. Notably, a cover may be removably attached to the mounting surface 310 to provide ornamental properties of the wheel 300. On the other hand, the mounting surface 310 may have ornamental properties such that the cover is omitted. As such, the mounting surface 310 may substantially enclose the interior region 330 of the wheel 300.

The electric motor 200 (simply referred to as ‘motor 200’) includes a rotor 210, a stator assembly 220 having a stator core 220c and a stator windings 220w, and inverter 230. The inverter 230 controls frequency of power supplied to the motor to control rotational speed of the rotor 210 (and also rotational speed of the wheel 300 and the rotatable portion 380R of the vehicle hub assembly 380 coupled for common rotation with the rotor 210. The inverter 230 receives direct current (DC) power supplied from one or more energy storage devices (e.g., batteries) (not shown) disposed within the vehicle (not shown) and converts the DC power into alternating current (AC) for powering the motor 200. For simplicity, the inverter 230 is only illustrated in the rotor-wheeled assembly 100 of FIG. 1A and may be disposed at any suitable location within the interior region 330 of the wheel 300 of the rotor-wheeled assembly 100 of FIGS. 1A-1G.

The vehicle hub assembly 380 includes the rotating portion 380R and a fixed portion 380F. As the rotating portion 380R is coupled for common rotation about the axis of rotation R with the wheel 300 and the rotor 210, the fixed portion 380F of the vehicle hub assembly 380 remains stationary during operation of the electric motor 200. In some configurations (FIGS. 1A and 1E-1G), the rotating portion 380R circumscribes the fixed portion 380F such that the fixed portion 380F supports the outer rotating portion 380R whereby bearings 382 permit the rotating portion 380R to rotate about the axis of rotation R relative to the stationary fixed portion 380F during operation of the electric motor 200. In other configurations (FIGS. 1B-1D), the stationary fixed portion 380F and the stator core 220c circumscribe the rotating portion 380R such that the rotating portion 380R supports the outer fixed portion 380F and stator core 220c. In these configurations, the bearings 382 are also interspersed between the rotating portion 380R and the outer fixed portion 380S to permit the rotating portion 380R to rotate about the axis of rotation R relative to the stationary fixed portion 380F during operation of the electric motor 200.

The fixed portion 380R is fixedly attached to the stator core 220c and is configured to mount the vehicle hub assembly 380 to the vehicle via one or more attachment features 385. To reduce space requirements of the motor 200 within the interior region 330 of the wheel 300, the stator core 220c may be integral with the fixed portion 380F of the vehicle hub assembly 380. For instance, the stator core 220c and the fixed portion 380F may be integrally formed with one another.

With continued reference to the rotor-wheeled assembly 100 of FIGS. 1A-1G, diagonal lines (such as those of the mounting surface 310, the interior radial surface 328, and the inner mounting surface 332) indicate cooling featuress (such as blades, fins, or vents) of an in-wheel cooling system incorporated into the rotor-wheeled assembly 100 for cooling the components (e.g., rotor 210 and stator assembly 220) of the electric motor 200 during operations thereof. Described in greater detail below, structure of the wheel 300 may include any combination of cooling vents and cooling blades/fins incorporated into the rotor-wheeled assembly 100 to provide cooling of the electric motor 200. For instance, cooling vents may be formed through and/or into surfaces of the mounting surface 310 and/or rim 320 of the wheel 300 that direct a flow of air into the interior region 330 of the wheel 300 for cooling the motor 200 residing therein. Likewise, cooling blades/fins may axially protrude into the interior region 330 from at least one of an interior side of the mounting surface 310 of the wheel 300 or the rotating portion 380R of the vehicle hub assembly 380. Additionally or alternatively, cooling blades/fins may radially protrude into the interior region 330 from the interior radial surface 328 of the rim 320. The cooling blades/fins axially and/or radially protruding into the interior region 330 of the wheel 300 are configured to circulate the flow of air within the interior region 330 while the wheel 300 is rotating relative to the axis of rotation R.

The in-wheel cooling system may eliminate the need of to employ an external cooling system that pumps a cooling fluid through a series of cooling lines interspersed within the interior region. In some examples, the rotor-wheeled assembly 100 also employs cooling from an external cooling system in combination with the in-wheel cooling system, however, the cooling provided by the in-wheel cooling system allows the number and/or size of the cooling lines associated with the external cooling system to be drastically reduced (i.e., downsized).

Referring to FIGS. 1A and 1B, in some implementations, the rotor-wheeled motor assembly 100 includes a one-sided axial motor 200 in which the rotor 210 is disposed on (or embedded into) the mounting surface 310 of the wheel 300 and axially opposing the stator windings 220w of the stator assembly 220. An axial flux air gap G separates the rotor 210 and the stator windings 220w. In the example shown, the one-sided axial motor 200 includes a PM motor 200 in which the rotor 210 includes one or more permanent magnets axially protruding into the interior region 330 of the wheel 300 from the interior side of the mounting surface 310 of the wheel 300. In other examples, the one-sided axial motor 200 includes an induction or reluctance motor 200 in which the rotor 210 includes rotor bars axially opposed to, and separated by the axial flux air gap G, to the stator windings 220w. The axial placement of the rotor 210 against the stator windings 220w may increase efficiency of the motor 200 compared to conventional radial motors.

The rotor-wheeled motor assembly 100 of FIG. 1A shows the stationary stator assembly 220 and the fixed portion 380F of the vehicle hub assembly 380 rotatably supporting (e.g., via bearings) the rotating portion 380R of the vehicle hub assembly 380. That is, the rotating portion 380R is disposed radially outward from the stationary fixed portion 380F of the hub assembly 380. Here, the rotating portion 380R is coupled for common rotation about the axis of rotation R with the wheel 300 via the one or more fasteners 313 securing the mounting surface 310 of the wheel 300 to the rotating portion 380R of the vehicle hub assembly 380. Because the rotor 210 is disposed at the mounting surface 310, the rotor 210 rotates with the mounting surface 310 about the axis of rotation R along a plane perpendicular to the axis of rotation R and axially outward of the stator windings 220w.

By contrast, the rotor-wheeled motor assembly 100 of FIG. 1B shows the rotating portion 380R of the vehicle hub assembly 380 instead supporting the stator assembly 220 and the stationary fixed portion 380F of the vehicle hub assembly 380. In other words, the rotating portion 380R of the hub assembly 380 is disposed radially inboard of the stationary fixed portion 380F. The bearings 382 interspersed between the rotating portion 380R and the fixed portion 380F and the stator assembly 220 permit the rotating portion 380R to rotate about the axis of rotation R relative to the fixed portion 380F and the stator assembly 220. Here, the rotating portion 380R is coupled for common rotation about the axis of rotation R with the wheel 300 via the one or more fasteners 313 securing the mounting surface 310 of the wheel 300 to the rotating portion 380R of the vehicle hub assembly 380. In some examples, the fixed portion 380F of the vehicle hub assembly 380 integrates the stator core 220c to save space within the interior region 330. Because the rotor 210 is disposed at the mounting surface 310, the rotor 210 rotates with the mounting surface 310 about the axis of rotation R along a plane perpendicular to the axis of rotation R and axially outward of the stator windings 220w.

FIGS. 1A and 1B also show the in-wheel cooling system including cooling vents formed through and/or into the mounting surface 310 of the wheel 300 that direct the flow of air into the interior region 330 of the wheel 300 for cooling the one-sided axial motor 200. Cooling channels may be formed into surfaces of the mounting surface 310 and/or rotor 210 to circulate the flow of air within the interior region 330. The in-wheel cooling system may also include cooling vents and/or channels formed through and/or into the rim 320 of the wheel 300. Without departing from the scope of the present disclosure, the in-wheel cooling system (e.g., diagonal lines) of FIG. 1A may include cooling blades/fins (not shown) protruding into the interior region 330 for cooling of the one-sided axial motor 200 in addition to, or in lieu of, cooling vents/channels.

Referring to FIG. 1C, in some implementations, the rotor-wheeled motor assembly 100 includes a two-sided axial motor 200. The two-sided axial motor 200 includes a first rotor 210, 210a disposed on or embedded into the mounting surface 310 of the wheel 300 and axially opposing a first set of stator windings 220w, 220wa, and a second rotor 210, 210b disposed on an inner mounting surface or portion 332 of the wheel 300 and axially opposing a second set of stator windings 220w, 220wb. The inner mounting portion 332 is within the interior chamber 330 of the wheel 300 and spaced from the mounting surface 310 so that the stator assembly 220 and stator windings 220w are disposed between and sandwiched by the first rotor 210a and the second rotor 210b. As shown, respective axial flux air gaps G are disposed between both the first rotor 210a and the first set of stator windings 220wa and the second rotor 210b and the second set of stator windings 220wb. In other words, the stator 220 and the rotor 210 are double sided, which increases the total airgap flux density, increasing efficiency of the motor 200.

The rotor-wheeled motor assembly 100 of FIG. 1C shows the rotating portion 380R of the vehicle hub assembly 380 supporting the stator assembly 220 and the stationary fixed portion 380F of the vehicle hub assembly 380. In other words, the rotating portion 380R of the vehicle hub assembly 380 is disposed radially inward of the stationary fixed portion 380F. The bearings 382 interspersed between the rotating portion 380R and the fixed portion 380F and the stator assembly 220 permit the rotating portion 380R to rotate about the axis of rotation R relative to the fixed portion 380F and the stator assembly 220. The mounting surface 310 and the inner mounting portion 332 of the wheel 300 rotate with the wheel 300 so that the stator assembly 220 is fixed relative to the rotating rotor 210. For example, the inner mounting portion 332 extends from the rotating portion 380R of the vehicle hub assembly 380 and parallel to the mounting surface 310. Here, the rotating portion 380R is coupled for common rotation about the axis of rotation R with the wheel 300 via the one or more fasteners 313 securing the mounting surface 310 of the wheel to the rotating portion 380R of the vehicle hub assembly 380. In some examples, the fixed portion 380F of the vehicle hub assembly 380 integrates the stator core 220c to save space within the interior region 330. Because the first rotor 210a is disposed at the mounting surface 310 and the second rotor 210b is disposed at the mounting portion 332, the rotors 210 rotate about the axis of rotation R along respective planes perpendicular to the axis of rotation R and on opposing sides of the stator windings 220w.

FIG. 1C also shows the in-wheel cooling system including cooling vents formed through and/or into the mounting surface 310 of the wheel 300 that direct the flow of air into the interior region 330 of the wheel 300 for cooling the two-sided axial motor 200. Cooling channels may be formed into surfaces of the mounting surface 310 and/or rotor 210 to circulate the flow of air within the interior region 330. The in-wheel cooling system may also include cooling vents and/or channels formed through and/or into the rim 320 of the wheel 300, such as along the interior radial wall 328 of the wheel 300. The cooling vents and/or channels are formed through the inner mounting portion 332 of the wheel 300 to further promote cooling airflow within the interior region 330. Without departing from the scope of the present disclosure, the in-wheel cooling system (e.g., diagonal lines) of FIG. 1C may include cooling blades/fins (not shown) protruding into the interior region 330 for cooling of the two-sided axial motor 200 in addition to, or in lieu of, cooling vents/channels. A liquid cooling system may additionally provide cooling for the motor 200 via a series of cooling conduits interspersed through the interior region 330 for circulating liquid to remove heat from the motor. The in-wheel cooling system may reduce the size and/or number of cooling conduits required by the liquid cooling system.

Referring to FIG. 1D, in some implementations, the rotor-wheeled motor assembly 100 includes a two-sided radial motor 200. In contrast to the motors 200 depicted in FIGS. 1A-1C, which operate to axially rotate about the axis of rotation R on a plane perpendicular to the axis of rotation R, the radial motor 200 operates to radially rotate the rotor 210 (and therefore wheel 300) about the axis of rotation R on a plane parallel to the axis of rotation R.

The two-sided radial motor 200 includes a first rotor 210a disposed on or embedded into the interior radial wall 328 of the rim 320 and opposing a first set of stator windings 220wa, and a second rotor 210b disposed on the rotating portion 380R of the hub assembly 380 and opposing a second set of stator windings 220wb. Optionally, the second rotor 210b is disposed on an inner mounting portion 332 of the wheel 300 that rotates with the rotating portion 380R of the hub assembly 380, such that the second rotor 210b circumscribes the rotating portion 280R rather than being disposed on or embedded directly in the hub assembly 380. Thus, the stator windings 220w are disposed between and sandwiched by the first rotor 210a and the second rotor 210b. As shown, respective radial flux air gaps G are disposed between both the first rotor 210a and the first set of stator windings 220wa and the second rotor 210b and the second set of stator windings 220wb. In other words, the stator 220 and the rotor 210 are double sided, which increases the total airgap flux density, increasing efficiency of the motor 200.

The rotor-wheeled motor assembly 100 of FIG. 1D shows the rotating portion 380R of the vehicle hub assembly 380 supporting the stator assembly 220 and the stationary fixed portion 380F of the vehicle hub assembly 380. In other words, the rotating portion 380R of the vehicle hub assembly 380 is disposed radially inboard of the stationary fixed portion 380F. The bearings 382 are interspersed in the flux air gap G between the first rotor 210a and the first set of stator windings 220wa to permit the rotating portion 380R to rotate about the axis of rotation R relative to the fixed portion 380F and the stator assembly 220. Here, the rotating portion 380R is coupled for common rotation about the axis of rotation R with the wheel 300 via the one or more fasteners 313 securing the mounting surface 310 of the wheel to the rotating portion 380R of the vehicle hub assembly 380. In some examples, the fixed portion 380F of the vehicle hub assembly 380 integrates the stator core 220c to save space within the interior region 330. The mounting surface 310 and the inner mounting portion 332 of the wheel 300 rotate with the wheel 300 so that the stator assembly 220 is fixed relative to the rotating rotor 210. For example, the inner mounting portion 332 extends from the rotating portion 380R of the vehicle hub assembly 380 and parallel to the mounting surface 310. Thus, the rotors 210 rotate about the axis of rotation R and parallel to the axis of rotation with the stator windings 220w disposed axially between the respective rotors 210.

FIG. 1D also shows the in-wheel cooling system including cooling vents formed through and/or into the mounting surface 310 of the wheel 300 that direct the flow of air into the interior region 330 of the wheel 300 for cooling the two-sided radial motor 200. Cooling channels may be formed into surfaces of the mounting surface 310 and/or rotor 210 to circulate the flow of air within the interior region 330. The cooling vents and/or channels are formed through the inner mounting portion 332 of the wheel 300 to further promote cooling airflow within the interior region 330. Without departing from the scope of the present disclosure, the in-wheel cooling system (e.g., diagonal lines) of FIG. 1D may include cooling blades/fins (not shown) protruding into the interior region 330 for cooling of the two-sided radial motor 200 in addition to, or in lieu of, cooling vents/channels.

Referring to FIG. 1E, in some implementations, the rotor-wheeled motor assembly includes a combined radial-axial motor 200. The radial-axial motor 200 includes a first, axial rotor 210 disposed on or embedded into the rotating portion 380R of the hub assembly 380 (or optionally, the mounting surface 310 of the wheel 300) and axially opposing the stator windings 220w, and a second, radial rotor 210b disposed on or embedded into the interior radial wall 328 of the rim 320 and opposing the stator windings 220w. Optionally, the stator windings 220w include first and second sets of stator windings, where the first set are opposing the first rotor 210a and the second set are opposing the second rotor 210b. Thus, the first rotor 210a and the second rotor 210b are disposed along adjacent, perpendicular sides of the stator windings 220w with an axial flux air gap G disposed between the first rotor 210a and the stator windings 210w and a radial flux air gap G disposed between the second rotor 210b and the stator windings 210w. This radial-axial arrangement between the first and second rotors 210a, 210b and the stator windings 210w increases the total airgap flux density of the motor 200 and utilizes stray flux from the stator windings 220w on both the axial and radial paths.

The rotor-wheeled motor assembly 100 of FIG. 1E shows the stationary stator assembly 220 and the fixed portion 380F of the vehicle hub assembly 380 rotatably supporting (e.g., via bearings 382) the rotating portion 380R of the vehicle hub assembly 380. That is, the rotating portion 380R is disposed radially outward from the stationary fixed portion of the hub assembly 380. Here, the rotating portion 380R is coupled for common rotation about the axis of rotation R with the wheel 300 via the one or more fasteners 313 securing the mounting surface 310 of the wheel 300 to the rotating portion 380R of the vehicle hub assembly 380. The first rotor 210a is disposed at the rotating portion 380R of the hub assembly 380 facing the stator windings 220w and thus rotates about the axis of rotation R along a plane perpendicular to the axis of rotation R and closer to the mounting surface 310 than the stator windings 220w. The second rotor 210b is disposed at the radial inner wall 328 of the rim 320 and thus rotates about the axis of rotation R and parallel to the axis of rotation R radially outward of the stator windings 220w.

FIG. 1E also shows the in-wheel cooling system including cooling vents formed through and/or into the mounting surface 310 of the wheel 300 that direct the flow of air into the interior region 330 of the wheel 300 for cooling the radial-axial motor 200. Cooling channels may be formed into surfaces of the mounting surface 310 and/or rotor 210 to circulate the flow of air within the interior region 330. The in-wheel cooling system may also include cooling vents and/or channels formed through and/or into the rim 320 of the wheel 300, such as along the interior radial wall 328 of the wheel 300. Without departing from the scope of the present disclosure, the in-wheel cooling system (e.g., diagonal lines) of FIG. 1E may include cooling blades/fins (not shown) protruding into the interior region 330 for cooling of the radial-axial motor 200 in addition to, or in lieu of, cooling vents/channels.

Referring to FIG. 1F, in some implementations, the rotor-wheeled motor assembly 100 includes a transverse rotor motor 200 in which the rotor 210 is disposed on (or embedded into) the rotational portion 380R of the hub assembly 380 and surrounding or sandwiching the stator windings 220w. Here the stator windings 220w are disposed on the fixed portion 380F of the hub assembly 380 radially inboard of the rotor 210. Optionally, the rotor 210 is disposed at or extends from the inner mounting surface or portion 332 of the wheel 300, where the inner mounting portion 332 extends from and rotates in unison with the rotating portion 380R of the hub assembly 380 about the axis of rotation R. In the example shown, the rotor 210 has a substantially U-shaped construction to form a channel and, when the rotor 210 rotates about the axis of rotation R relative to the stator windings 220w, the stator windings 220w pass along the U-shaped channel. Thus, the flux air gap G separates the rotor 210 and the stator windings 220w, where the space between the rotor 210 and the stator windings 220w forms a substantially U-shaped flux air gap G.

The rotor-wheeled motor assembly 100 of FIG. 1F shows the stationary stator assembly 220 and the fixed portion 380F of the vehicle hub assembly 380 rotatably supporting (e.g., via bearings 382) the rotating portion 380R of the vehicle hub assembly 380. That is, the rotating portion 380R is disposed radially outward from the stationary fixed portion 380F of the hub assembly 380. Here, the rotating portion 380R is coupled for common rotation about the axis of rotation R with the wheel 300 via the one or more fasteners 313 securing the mounting surface 310 of the wheel 300 to the rotating portion 380R of the vehicle hub assembly 380. The rotor 210 rotates about the axis of rotation R and parallel to the axis of rotation R radially outward of the stator windings 220w.

FIG. 1F also shows the in-wheel cooling system including cooling vents formed through and/or into the mounting surface 310 of the wheel 300 that direct the flow of air into the interior region 330 of the wheel 300 for cooling the transverse rotor motor 200. Cooling channels may be formed into surfaces of the mounting surface 310 and/or rotor 210 to circulate the flow of air within the interior region 330. The in-wheel cooling system may also include cooling vents and/or channels formed through and/or into the rim 320 of the wheel 300, such as along the interior radial wall 328 of the wheel 300. The cooling vents and/or channels are formed through the inner mounting portion 332 of the wheel 300 to further promote cooling airflow within the interior region 330. Without departing from the scope of the present disclosure, the in-wheel cooling system (e.g., diagonal lines) of FIG. 1F may include cooling blades/fins (not shown) protruding into the interior region 330 for cooling of the transverse rotor motor 200 in addition to, or in lieu of, cooling vents/channels.

Referring to FIG. 1G, in some implementations, the rotor-wheeled motor assembly 100 includes a transverse stator motor 200 in which the rotor 210 is disposed on or extends from the rotational portion 380R of the hub assembly 380 and is surrounded by or sandwiched by the stator windings 220w disposed on the stationary fixed portion 380F of the hub assembly 380. In the example shown, the stator winding 220w has a substantially U-shaped construction to form a channel and, when the rotor 210 rotates about the axis of rotation R relative to the stator windings 220w, the rotor 210 passes along the U-shaped channel. Thus, the flux air gap G separates the rotor 210 and the stator windings 220w, whereby the space between the rotor 210 and the stator windings 220w forms a substantially U-shaped flux air gap G.

The rotor-wheeled motor assembly 100 of FIG. 1G shows the stationary stator assembly 220 and the fixed portion 380F of the vehicle hub assembly 380 rotatably supporting (e.g., via bearings 382) the rotating portion 380R of the vehicle hub assembly 380. That is, the rotating portion 380R is disposed radially outward from the stationary fixed portion 380F of the hub assembly 380. Here, the rotating portion 380R is coupled for common rotation about the axis of rotation R with the wheel 300 via the one or more fasteners 313 securing the mounting surface 310 of the wheel 300 to the rotating portion 380R of the vehicle hub assembly 380. The rotor 210 rotates about the axis of rotation R and parallel to the axis of rotation R and between opposing sides or faces of the U-shaped stator windings 220w.

FIG. 1G also shows the in-wheel cooling system including cooling vents formed through and/or into the mounting surface 310 of the wheel 300 that direct the flow of air into the interior region 330 of the wheel 300 for cooling the transverse stator motor 200. Cooling channels may be formed into surfaces of the mounting surface 310 and/or rotor 210 to circulate the flow of air within the interior region 330. The in-wheel cooling system may also include cooling vents and/or channels formed through and/or into the rim 320 of the wheel 300, such as along the interior radial wall 328 of the wheel 300. Without departing from the scope of the present disclosure, the in-wheel cooling system (e.g., diagonal lines) of FIG. 1G may include cooling blades/fins (not shown) protruding into the interior region 330 for cooling of the transverse stator motor 200 in addition to, or in lieu of, cooling vents/channels.

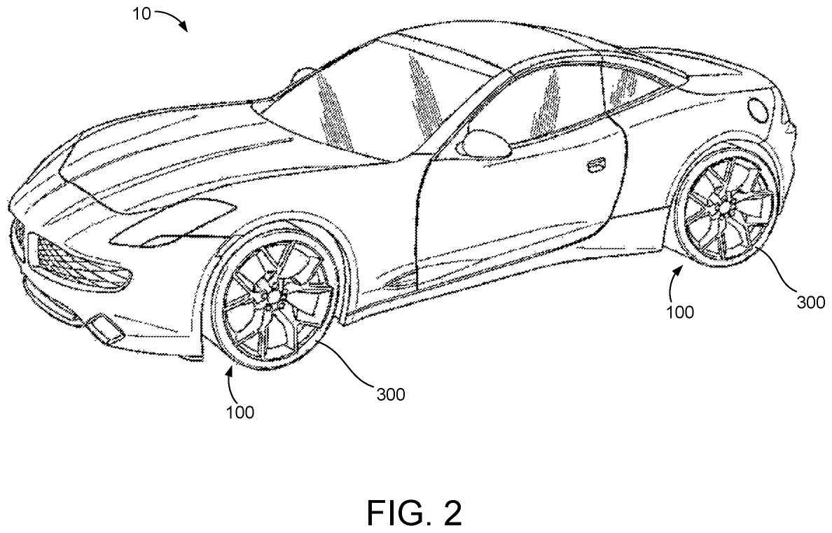

As shown in FIG. 2, a vehicle 10 is equipped with the rotor-wheeled motor assembly 100. In the example shown, the vehicle 10 includes a plurality of wheels 300 and each wheel 300 integrates an electric motor 200 into the interior region 330 of the wheel 300, as described above with reference to FIGS. 1A-1G. The vehicle 10 may include a fully electric vehicle powered solely by one or more rotor-wheeled motor assemblies installed on corresponding wheels of the vehicle or a hybrid electric vehicle that is powered by an engine and one or more rotor-wheeled motor assemblies installed on one or more wheels of the vehicle 10. Although the example shown depicts the vehicle 10 as a passenger car, the rotor-wheeled motor assembly 100 may be installed on any suitable vehicle 10, such as a truck or sport utility vehicle (SUV), a motor cycle, a mass transit, vehicle such as a bus or rail car, or an off-road or all-terrain vehicle. The rotor-wheeled motor assembly 100 may also be installed on other electric-powered or motor-driven vehicles, such as electric-assisted vehicles (e.g., a scooter or bicycle) or robots.

Furthermore, any number of wheels 300 of the vehicle 10 can be equipped with the rotor-wheeled motor assembly 100. In the example shown, each wheel 300 of the vehicle 10 includes the rotor-wheeled motor assembly. However, only a subset of wheels 300, such as the rear wheels or the front wheels, may include the rotor-wheeled motor assembly 100.

A number of implementations have been described. Nevertheless, it will be understood that various modifications may be made without departing from the spirit and scope of the disclosure. Accordingly, other implementations are within the scope of the following claims.

What is claimed is:

1. A rotor-wheeled motor assembly comprising:
a wheel comprising a rim coaxial with an axis of rotation of the wheel and circumscribing an interior region of the wheel, the rim having a tire mounting surface and an interior radial surface disposed on an opposite side of the rim than the tire mounting surface and opposing the interior region, the tire mounting surface arranged coaxially with the axis of rotation of the wheel and configured to mount the wheel to a vehicle hub assembly; and
an electric motor disposed within the interior region of the wheel, the electric motor comprising:
a first rotor disposed on or embedded into the tire mounting surface of the wheel, the first rotor configured to rotate in unison with the tire mounting surface about the axis of rotation along a plane perpendicular to the axis of rotation; and
a stator assembly comprising a stator core and a first set of stator windings, the first set of stator windings axially opposing the first rotor to define an axial flux air gap that separates the first rotor and the first set of stator windings.

2. The rotor-wheeled motor assembly of claim 1, wherein the rotor is disposed axially outward of the first set of stator windings.

3. The rotor-wheeled motor assembly of claim 1, wherein the electric motor further comprises:
a second rotor disposed on an inner mounting portion of the wheel, the inner mounting portion coupled for common rotation about the axis of rotation of the wheel with the tire mounting surface such the first rotor and the second rotor rotate in unison about the axis of rotation along respective planes perpendicular to the axis of rotation; and
a second set of stator windings axially opposing the second rotor.

4. The rotor-wheeled motor assembly of claim 1, wherein the rotor-wheeled motor assembly does not include a gearbox or transmission for transferring output torque from the electric motor for driving the wheel.

5. The rotor-wheeled motor assembly of claim 1, wherein the rotor-wheeled motor assembly is not cooled via liquid cooling.

6. The rotor-wheeled motor assembly of claim 1, wherein the rotor-wheeled motor assembly integrates conduits of an external liquid cooling system configured to circulate liquid for cooling the electric motor.

7. The rotor-wheeled motor assembly of claim 1, wherein the electric motor comprises a permanent magnet motor.

8. The rotor-wheeled motor assembly of claim 1, wherein the electric motor comprises an induction motor.

9. The rotor-wheeled motor assembly of claim 1, wherein the electric motor comprises a reluctance motor.

10. The rotor-wheeled motor assembly of claim 1, wherein the vehicle hub assembly comprises:
a rotating portion coupled for common rotation about the axis of rotation of the wheel; and
a fixed portion that remains stationary during operation of the electric motor.

11. The rotor-wheeled motor assembly of claim 10, wherein the rotating portion of the vehicle hub assembly circumscribes the fixed portion of the vehicle hub assembly.

12. The rotor-wheeled motor assembly of claim 10, wherein the fixed portion of the vehicle hub assembly circumscribes the rotating portion of the vehicle hub assembly.

13. The rotor-wheeled motor assembly of claim 10, further comprising bearings configured to permit the rotating portion of the vehicle hub assembly to rotate about the axis of rotation relative to the fixed portion of the vehicle hub assembly.

14. The rotor-wheeled motor assembly of claim 10, wherein the fixed portion of the vehicle hub assembly is fixedly attached to the stator.

15. The rotor-wheeled motor assembly of claim 1, further comprising an in-wheel cooling system configured to provide cooling to the electric motor disposed within the interior region of the wheel.

16. The rotor-wheeled motor assembly of claim 15, wherein the in-wheel cooling system comprises vents formed through and or into the mounting surface of the wheel that direct a flow of air into the interior region during operation of the electric motor.

17. The rotor-wheeled motor assembly of claim 15, wherein the in-wheel cooling system comprises vents formed through and or into the first rotor that direct a flow of air into the interior region during operation of the electric motor.

18. The rotor-wheeled motor assembly of claim 15, wherein the in-wheel cooling system comprises cooling blades/fins that protrude into the interior region of the wheel.

19. The rotor-wheeled motor assembly of claim 1, wherein the electric motor further comprises an inverter disposed in the interior region of the motor, the inverter configured to convert direct current power supplied from one or more energy storage devices into alternating current for powering the electric motor.

20. The rotor-wheeled motor assembly of claim 1, wherein the wheel is disposed on a car, truck, robot, or motor cycle.

21. A rotor-wheeled motor assembly comprising:
a wheel comprising a rim coaxial with an axis of rotation of the wheel and circumscribing an interior region of the wheel, the rim having a tire mounting surface and an interior radial surface disposed on an opposite side of the rim than the tire mounting surface and opposing the interior region, the tire mounting surface arranged coaxially with the axis of rotation of the wheel and configured to mount the wheel to a vehicle hub assembly; and
an electric motor disposed within the interior region of the wheel, the electric motor comprising:
a first rotor disposed on or embedded into the interior radial surface of the rim of the wheel, the first rotor configured to rotate in unison with the rim about the axis of rotation along a plane parallel to the axis of rotation; and
a stator assembly comprising a stator core and a first set of stator windings, the first set of stator windings radially opposing the first rotor to define a radial flux air gap that separates the first rotor and the first set of stator windings.

22. The rotor-wheeled motor assembly of claim 21, wherein the electric motor further comprises:
a second rotor disposed on a rotating portion of the vehicle hub assembly, the rotating portion coupled for common rotation about the axis of rotation with the rim such the first rotor and the second rotor rotate in unison about the axis of rotation R along respective planes parallel to the axis of rotation; and
a second set of stator windings radially opposing the second rotor to define another radial air gap that separates the second rotor and the second set of stator windings.

23. The rotor-wheeled motor assembly of claim 21, wherein the electric motor further comprises a second rotor disposed on or embedded into one of the tire mounting surface or a rotating portion of the vehicle hub assembly, the second rotor configured to rotate in unison with the tire mounting surface about the axis of rotation along a plane perpendicular to the axis of rotation.

24. The rotor-wheeled motor assembly of claim 21, wherein the rotor-wheeled motor assembly does not include a gearbox or transmission for transferring output torque from the electric motor for driving the wheel.

25. The rotor-wheeled motor assembly of claim 21, wherein the rotor-wheeled motor assembly is not cooled via liquid cooling.

26. The rotor-wheeled motor assembly of claim 21, wherein the rotor-wheeled motor assembly integrates conduits of an external liquid cooling system configured to circulate liquid for cooling the electric motor.

27. The rotor-wheeled motor assembly of claim 21, wherein the electric motor comprises a permanent magnet motor.

28. The rotor-wheeled motor assembly of claim 21, wherein the electric motor comprises an induction motor.

29. The rotor-wheeled motor assembly of claim 21, wherein the electric motor comprises a reluctance motor.

30. The rotor-wheeled motor assembly of claim 21, wherein the vehicle hub assembly comprises:
a rotating portion coupled for common rotation about the axis of rotation of the wheel; and
a fixed portion that remains stationary during operation of the electric motor.

31. The rotor-wheeled motor assembly of claim 30, wherein the rotating portion of the vehicle hub assembly circumscribes the fixed portion of the vehicle hub assembly.

32. The rotor-wheeled motor assembly of claim 30, wherein the fixed portion of the vehicle hub assembly circumscribes the rotating portion of the vehicle hub assembly.

33. The rotor-wheeled motor assembly of claim 30, further comprising bearings configured to permit the rotating portion of the vehicle hub assembly to rotate about the axis of rotation relative to the fixed portion of the vehicle hub assembly.

34. The rotor-wheeled motor assembly of claim 30, wherein the fixed portion of the vehicle hub assembly is fixedly attached to the stator.

35. The rotor-wheeled motor assembly of claim 31, further comprising an in-wheel cooling system configured to provide cooling to the electric motor disposed within the interior region of the wheel.

36. The rotor-wheeled motor assembly of claim 35, wherein the in-wheel cooling system comprises vents formed through and or into the mounting surface of the wheel that direct a flow of air into the interior region during operation of the electric motor.

37. The rotor-wheeled motor assembly of claim 35, wherein the in-wheel cooling system comprises vents formed through and or into the first rotor that direct a flow of air into the interior region during operation of the electric motor.

38. The rotor-wheeled motor assembly of claim 35, wherein the in-wheel cooling system comprises cooling blades/fins that protrude into the interior region of the wheel.

39. The rotor-wheeled motor assembly of claim 31, wherein the electric motor further comprises an inverter disposed in the interior region of the motor, the inverter configured to convert direct current power supplied from one or more energy storage devices into alternating current for powering the electric motor.

40. The rotor-wheeled motor assembly of claim 31, wherein the wheel is disposed on a car, truck, robot, or motor cycle.
